(19) United States
(12) Patent Application Publication
(10) Pub. No.: US 2024/0109581 A1
(43) Pub. Date: Apr. 4, 2024

(54) BLIND SPOT GUIDANCE SYSTEM FOR A VEHICLE

(71) Applicant: GM Global Technology Operations LLC, Detroit, MI (US)

(72) Inventor: Mohamed A. Layouni, Fraser, MI (US)

(21) Appl. No.: 17/936,546

(22) Filed: Sep. 29, 2022

(51) Int. Cl. B62D 5/00; B60W 10/18; B60W 10/20; B60W 30/09; B60W 30/095; B60W 30/18; B60W 40/04; B60W 50/00; B60W 50/16; G06V 20/56

(52) U.S. Cl. CPC B62D 5/005; B60W 10/18; B60W 10/20; B60W 30/09; B60W 30/0956; B60W 30/18163; B60W 40/04; B60W 50/0097; B60W 50/16; G06V 20/588; B60W 2050/143

(57) ABSTRACT

A blind spot guidance system for a vehicle includes a perception system, an electric motor, and one or more controllers. The one or more controllers execute instructions to monitor a trajectory of the vehicle to determine when a lane change maneuver to manipulate the vehicle from a current lane of travel to an adjacent lane of travel is being initiated. In response to determining the lane change maneuver is being initiated, the one or more controllers monitor the perception system for a moving obstacle located in a blind spot of the vehicle. In response to determining the moving obstacle is located in the blind spot of the vehicle, the one or more controllers instruct the electric motor to generate an assist torque provided to a hand wheel, wherein the assist torque guides the vehicle back into the current lane of travel.

### INTRODUCTION

The present disclosure relates to a blind spot guidance system for a vehicle, where the blind spot guidance system guides the vehicle back into a current lane of travel in response to determining a user is initiating a lane change maneuver when a moving obstacle is located in the blind spot of the vehicle.

Many vehicles include various types of driver assist systems that employ advanced technology to assist an individual when operating a vehicle. For example, a lane keeping assist system prevents a driver from unintentionally drifting out of the vehicle's intended lane while driving. A lane keeping assist system employs image sensors that detect lane markings ahead of the vehicle and monitor the vehicle's position within the respective lane. When the vehicle's distance to the lane markings falls below a defined threshold, the lane keeping assist system may instruct an electric power steering (EPS) system to gently nudge the vehicle back into the intended lane. Specifically, the EPS system includes an electric motor that exerts a relatively light assist torque upon the vehicle's steering wheel to nudge the vehicle back into the intended lane when the driver inadvertently allows the vehicle to drift.

It is to be appreciated that lane keeping assist systems are intended to correct unintentional lane drift when the driver is distracted or inattentive, and not when the driver is performing an intentional maneuver such as a lane change. In fact, lane keeping assist systems are disabled when a driver actives the vehicle's turn signal. However, sometimes it may also be useful to provide guidance or to a driver when he or she is performing intentional maneuvers while driving. For example, sometimes a driver may inadvertently forget to check the vehicle's blind spot before making a lane change while driving. Therefore, the driver may not be aware there is another vehicle present in the blind spot when making the lane change.

Thus, while current driver assist systems achieve their intended purpose, there is a need in the art for an improved approach for correcting intentional maneuvers made by a driver of a vehicle.

### SUMMARY

According to several aspects, a blind spot guidance system for a vehicle is disclosed. The blind spot guidance system includes a perception system collecting perception data indicating objects located in an environment surrounding the vehicle, an electric motor providing an assist torque to a hand wheel of the vehicle, and one or more controllers in electronic communication with the perception system and the electric motor. The one or more controllers execute instructions to monitor a trajectory of the vehicle to determine when a lane change maneuver to manipulate the vehicle from a current lane of travel to an adjacent lane of travel is being initiated. In response to determining the lane change maneuver is being initiated, the one or more controllers monitor the perception data collected by the perception system for a moving obstacle located in a blind spot of the vehicle, where the blind spot is disposed in the adjacent lane of travel. In response to determining the moving obstacle is located in the blind spot of the vehicle, the one or more controllers instruct the electric motor to generate the assist torque provided to the hand wheel, where the assist torque guides the vehicle back into the current lane of travel.

In an aspect, the blind spot guidance system includes one or more notification devices in electronic communication with the one or more controllers, where the one or more notification devices are activated to create an alert.

In another aspect, in response to determining the moving obstacle is located in the blind spot of the vehicle, the one or more controllers activate the one or more notification devices to create the alert.

In yet another aspect, the assist torque overrides a force generated by a user upon the hand wheel as the lane change maneuver is initiated.

In an aspect, the blind spot guidance system further includes one or more image capturing devices that collect image data representative of an environment surrounding the vehicle.

In another aspect, the one or more controllers determine the trajectory of the vehicle based on the image data collected by the one or more image capturing devices.

In yet another aspect, the one or more controllers execute instructions to detect lane lines along a roadway that the vehicle is traveling along based on the image data collected by the one or more image capturing devices. The one or more controllers measure a distance between the vehicle and the lane lines along the roadway. The one or more controllers compare the distance with a lane change prediction distance, where the lane change prediction distance represents a predefined distance indicating a user of the vehicle is approaching the lane lines and intends to perform the lane change maneuver. The one or more controllers determine the distance between the vehicle and the lane lines is equal to or greater than the lane change prediction distance for a predefined amount of time. Finally, in response to determining the distance between the vehicle and the lane lines is equal to or greater than the lane change prediction distance for the predefined amount of time, the one or more controllers determine the lane change maneuver is being initiated.

In an aspect, the blind spot detection system includes a turn signal system in electronic communication with the one or more controllers.

In another aspect, the one or more controllers determine the trajectory of the vehicle based on the turn signal system being activated.

In yet another aspect, in response to determining the moving obstacle is located in the blind spot of the vehicle, the one or more controllers monitor the perception system for an obstacle located in in a region located in front of the vehicle in the current lane of travel.

In an aspect, a blind spot guidance system for a vehicle is disclosed. The blind spot guidance system includes a perception system collecting perception data indicating objects located in an environment surrounding the vehicle, an electric motor providing an assist torque to a hand wheel of the vehicle, a braking system, and one or more controllers in electronic communication with the perception system, the electric motor, and the braking system. The one or more controllers execute instructions to monitor a trajectory of the vehicle to determine when a lane change maneuver to manipulate the vehicle from a current lane of travel to an adjacent lane of travel is being initiated. In response to determining the lane change maneuver is being initiated, the one or more controllers monitor the perception data collected by the perception system for a moving obstacle located in a blind spot of the vehicle, where the blind spot is disposed in the adjacent lane of travel. The one or more controllers determine the moving obstacle is located in the blind spot of the vehicle. In response to determining the moving obstacle is located in the blind spot of the vehicle, the one or more controllers monitor the perception system for an obstacle located in a region located in front of the vehicle in the current lane of travel. In response to determining an absence of the obstacle in the region located in front of the vehicle, the one or more controllers instruct the electric motor to generate the assist torque that is provided to the hand wheel, where the assist torque guides the vehicle back into the current lane of travel. In response to determining the obstacle is located in the region located in front of the vehicle, the one or more controllers instruct the braking system to stop the vehicle within a speed-defined distance to avoid the obstacle located in the region in front of the vehicle.

In an aspect, the blind spot guidance system includes one or more notification devices in electronic communication with the one or more controllers, where the one or more notification devices create an alert, and the alert is a haptic alert, an audio alert, or a visual alert.

In another aspect, in response to determining the moving obstacle is located in the blind spot of the vehicle, the one or more controllers activate the one or more notification devices to create the alert.

In yet another aspect, the assist torque overrides a force generated by a user upon the hand wheel as the lane change maneuver is initiated.

In an aspect, the blind spot guidance system includes one or more image capturing devices that collect image data representative of an environment surrounding the vehicle.

In another aspect, the one or more controllers determine the trajectory of the vehicle based on the image data collected by the one or more image capturing devices.

In still another aspect, the one or more controllers execute instructions to detect lane lines along a roadway that the vehicle is traveling along based on the image data collected by the one or more image capturing devices. The one or more controllers measure a distance between the vehicle and the lane lines along the roadway. The one or more controllers compare the distance with a lane change prediction distance, where the lane change prediction distance represents a predefined distance indicating a user of the vehicle is approaching the lane lines and intends to perform the lane change maneuver. The one or more controllers determine the distance between the vehicle and the lane lines is equal to or greater than the lane change prediction distance for a predefined amount of time. Finally, in response to determining the distance between the vehicle and the lane lines is equal to or greater than the lane change prediction distance for the predefined amount of time, the one or more controllers determine the lane change maneuver is being initiated.

In an aspect, the blind spot guidance system includes a turn signal system in electronic communication with the one or more controllers.

In another aspect, the one or more controllers determine the trajectory of the vehicle based on the turn signal system being activated.

In an aspect, a blind spot guidance system for a vehicle is disclosed, and includes a perception system collecting perception data indicating objects located in an environment surrounding the vehicle, a braking system including a set of brakes corresponding to each wheel of a plurality of wheels of the vehicle, and one or more controllers in electronic communication with the perception system and the braking system. The one or more controllers execute instructions to monitor a trajectory of the vehicle to determine when a lane change maneuver to manipulate the vehicle from a current lane of travel to an adjacent lane of travel is being initiated. In response to determining the lane change maneuver is being initiated, the one or more controllers monitor the perception data collected by the perception system for a moving obstacle located in a blind spot of the vehicle, where the blind spot is disposed in the adjacent lane of travel. In response to determining the moving obstacle is located in the blind spot of the vehicle, the one or more controllers instruct the braking system to selectively brake one or more wheels of the vehicle, where selectively braking the one or more wheels of the vehicle guides the vehicle back into the current lane of travel.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed blind spot guidance system including one or more controllers in electronic communication with an electric motor that is part of an electric power steering (EPS) system, according to an exemplary embodiment;

FIG. 2 illustrates the vehicle shown in FIG. 1 driving along a roadway, where a moving obstacle is located in a blind spot of the vehicle, according to an exemplary embodiment; and

FIG. 3 is a process flow diagram illustrating an exemplary method for generating an assist torque provided to a hand wheel to guide the vehicle back into a current lane of travel to avoid the moving obstacle located in the blind spot, according to an exemplary embodiment.

### DETAILED DESCRIPTION

The following description is merely exemplary in nature and is not intended to limit the present disclosure, application, or uses.

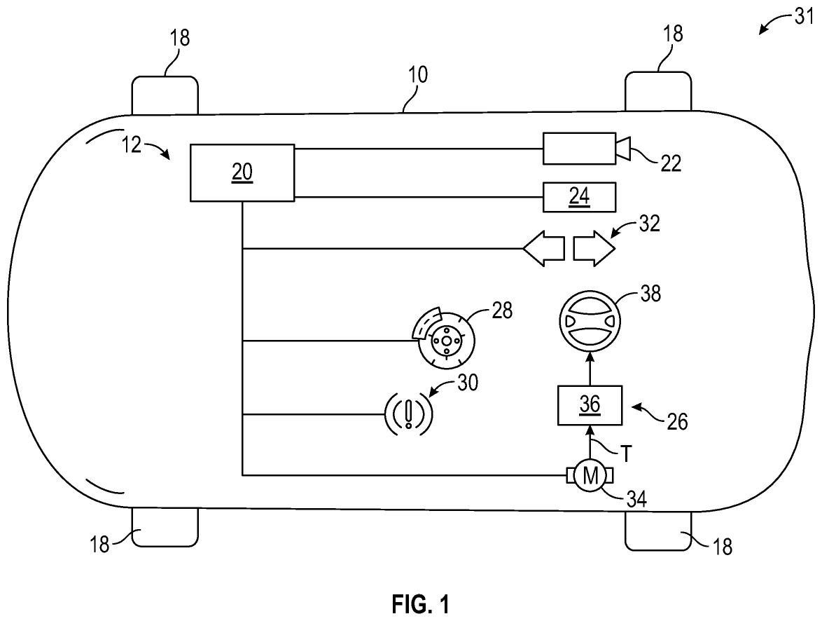

Referring to FIG. 1, an exemplary vehicle 10 including a blind spot guidance system 12 is illustrated. The vehicle 10 may be any type of vehicle such as, but not limited to, a sedan, truck, sport utility vehicle, van, a ride-share vehicle, or motor home. The blind spot guidance system 12 includes one or more controllers 20 in electronic communication with one or more image capturing devices 22, a perception system 24, an electric power steering (EPS) system 26, a braking system 28, one or more notification devices 30, and a turn signal system 32. The braking system 28 includes a set of brakes corresponding to each wheel 18 that is part of a plurality of wheels 18 of the vehicle 10. The one or more image capturing devices 22 include any device configured to collect image data representative of an environment 31 surrounding the vehicle 10 such as a camera. The EPS system 26 includes an electric motor 34 that provides an assist torque T to a hand wheel 38 that is part of a steering system 36 of the vehicle 10. The steering system 36 includes the hand wheel 38 and numerous gears, linkages, and other components for controlling a trajectory of the vehicle 10 by manipulating the wheels 18.

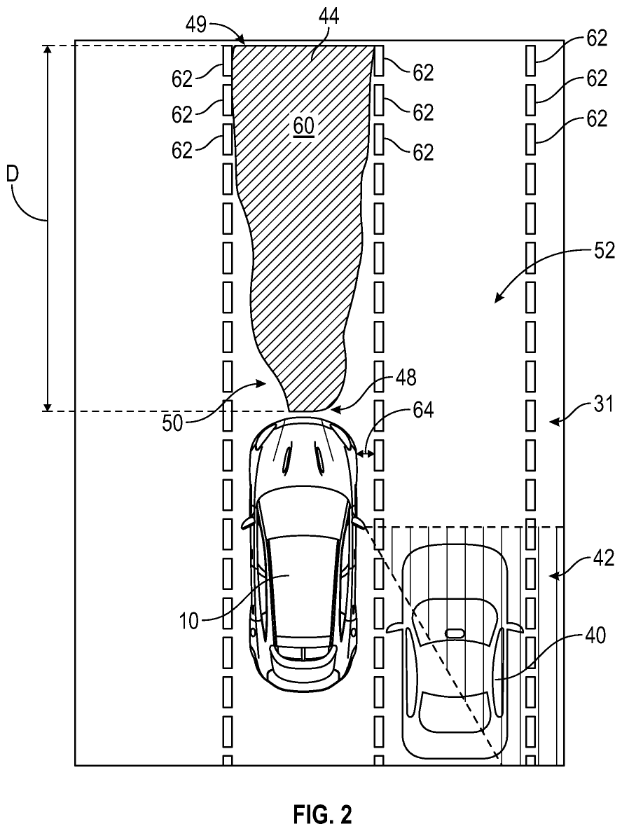

FIG. 2 is an illustration of the vehicle 10 driving along a roadway 44, where a moving obstacle 40 is located in the blind spot 42 of the vehicle 10. In the non-limiting embodiment as shown in FIG. 2, the moving obstacle 40 is another vehicle. However, it is to be appreciated that FIG. 2 is merely exemplary in nature, and the moving obstacle 40 may be any type of object traveling along a roadway. For example, in another embodiment, the moving obstacle 40 is a bicycle, a motorcycle, or any other type of vehicle.

Referring to FIGS. 1 and 2, in some instances a user of the vehicle 10 decides to perform a lane change maneuver to manipulate the vehicle 10 from a current lane of travel 50 to an adjacent lane of travel 52. However, as seen in FIG. 2, the moving obstacle 40 is located in the blind spot 42 of the vehicle 10 and in the adjacent lane of travel 52. It is to be appreciated that sometimes the user of the vehicle 10 may inadvertently forget to check the blind spot 42 of the vehicle 10 or does not see the moving obstacle 40 located in the blind spot 42 of the vehicle 10. As explained below, the blind spot guidance system 12 monitors a trajectory of the vehicle 10 to determine when the user is attempting to perform a lane change maneuver to manipulate the vehicle 10 from the current lane of travel 50 to the adjacent lane of travel 52. In response to determining the user is attempting to perform the lane change maneuver with the moving obstacle 40 located in the blind spot 42, the blind spot guidance system 12 first notifies the user by activating the one or more notification devices 30. If the user continues to perform the lane change maneuver, the blind spot guidance system 12 guides the vehicle 10 back into the current lane of travel 50. Specifically, the blind spot guidance system 12 instructs the electric motor 34 to generate the assist torque T that guides the vehicle 10 back into the current lane of travel 50. The assist torque T exerted upon the hand wheel 38 is sufficient to override a force generated by the user upon the hand wheel 38 while initiating the lane change maneuver. In another embodiment, instead of exerting the assist torque T upon the hand wheel 38, the blind spot guidance system 12 instructs the braking system 28 to adjust the trajectory of the vehicle 10 by selective braking. Specifically, the blind spot guidance system 12 instructs the braking system 28 to selectively brake one or more sets of brakes of the wheels 18 of the vehicle 10 to guide the vehicle 10 back into the current lane of travel 50.

Referring to FIG. 2, a region 60 is shown directly in front of the vehicle 10, in the current lane of travel 50. When an obstacle is located in the region 60 in front of the vehicle 10 and the moving obstacle 40 is present in the blind spot 42 of the vehicle 10, then the vehicle 10 may be attempting to perform the lane change maneuver to avoid contacting or creating a traffic incident with the obstacle located in the region 60 in front of the vehicle 10. For example, the vehicle 10 may be swerving into the adjacent lane of travel 52 to avoid contacting another vehicle located in the region 60 in front of the vehicle 10. A speed-defined distance D represents a length of the region 60 that extends along the current lane of travel 50. The speed defined distance D is measured from a front end 48 of the vehicle 10 to an end 49 of the region 60. The value of the speed-defined distance D is determined based on a current speed of the vehicle 10. For example, the speed-defined distance D increases as the current speed of the vehicle 10 increases and decreases as the current speed of the vehicle 10 decreases. Referring to FIGS. 1 and 2, when an obstacle, such as another vehicle, is located in the region 60 and the moving obstacle 40 is located in the blind spot 42, the one or more controllers 20 of the blind spot guidance system 12 instruct the braking system 28 to stop the vehicle 10 to avoid the obstacle located in the region 60 instead of instructing the electric motor 34 (FIG. 1) to generate the assist torque T for guiding the vehicle 10 back into the current lane of travel 50.

Referring to FIGS. 1 and 2, the perception system 24 includes sensors such as, but not limited to, short range radar, ultrasound sensors, and cameras. The perception system 24 collects perception data indicating objects located in the environment 31 surrounding the vehicle 10. In particular, the perception system 24 detects the moving obstacle 40 located in the blind spot 42 of the vehicle 10 as well as in the region 60 located in front of the vehicle 10 in the current lane of travel 50. In an embodiment, the perception system 24 includes one or more external vehicle networks. The one or more external vehicle networks may include, but are not limited to, cellular networks, dedicated short-range communications (DSRC) networks, and vehicle-to-infrastructure (V2X) networks. The perception system 24 may receive a message from the external vehicle network indicating the moving obstacle 40 is located in the blind spot 42 of the vehicle 10. In an embodiment, the perception system 24 may receive a message from the external vehicle network indicating that an obstacle is located in the region 60 in front of the vehicle 10.

The one or more notification devices 30 create an alert to capture the attention of a user, where the alert is a haptic alert, an audio alert, or a visual alert. Some example of notification devices 30 include, but are not limited to, haptic devices, speakers, and visual indicators. For example, a haptic device may be placed in a user's seat. In another example, a speaker may be used to generate an auditory notification. In yet another example, a visual alert may be generated by a head-up display (HUD). The one or more notification devices 30 are activated to create the alert in response to the one or more controllers 20 determining the user is attempting to perform the lane change maneuver with the moving obstacle 40 located in the blind spot 42 of the vehicle 10.

The one or more controllers 20 monitor a trajectory of the vehicle 10 to determine when the lane change maneuver to manipulate the vehicle 10 from the current lane of travel 50 to an adjacent lane of travel 52 is initiated. In one embodiment, the one or more controllers 20 determine the trajectory of the vehicle 10 based on the image data collected by the one or more image capturing devices 22. Specifically, referring to both FIGS. 1 and 2, the one or more controllers 20 execute instructions to detect lane lines 62 along the roadway 44 that the vehicle 10 is traveling along based on the image data collected by the one or more image capturing devices 22. The lane lines 62 divide the current lane of travel 50 from the adjacent lane of travel 52. The one or more controllers 20 measure a distance 64 between the vehicle 10 and the lane lines 62 along the roadway 44 and compare the distance 64 with a lane change prediction distance. The lane change prediction distance represents a predefined distance indicating the user of the vehicle 10 is approaching or encroaching the lane lines 62 and intends to perform the lane change maneuver and cross the lane lines 62 into the adjacent lane of travel 52. When the distance 64 between the vehicle 10 and the lane lines 62 is equal to or greater than the lane change prediction distance for a predefined amount of time, the one or more controllers 20 determine the lane change maneuver to manipulate the vehicle 10 from the current lane of travel 50 to the adjacent lane of travel 52 is being initiated.

In another embodiment, the one or more controllers 20 determine the trajectory of the vehicle 10 based on the turn signal system 32 being activated. Specifically, if the turn signal system 32 is activated to indicate the user intends to perform the lane change maneuver to drive the vehicle 10 from the current lane of travel 50 and in the direction towards the adjacent lane of travel 52, the one or more controllers 20 determine the lane change maneuver to manipulate the vehicle 10 from the current lane of travel 50 to the adjacent lane of travel 52 is being initiated.

In response to determining the lane change maneuver is being initiated, the one or more controllers 20 monitor the perception system 24 for the moving obstacle 40 located in a blind spot 42 of the vehicle 10. As seen in FIG. 2, the blind spot 42 is disposed in the adjacent lane of travel 52. In response to determining the moving obstacle 40 is located in the blind spot 42 of the vehicle 10 based on the perception data, the one or more controllers 20 activate the notification devices 30 to create the alert. The alert captures the attention of the user and is intended to alert the user of the moving obstacle 40 located in the blind spot 42 of the vehicle 10. For example, an audible alert may inform the user of a vehicle located in the blind spot 42.

It is to be appreciated that there is a possibility the user may disregard the alert and proceeds to execute the lane change maneuver, regardless of the alert. In this instance, the one or more controllers 20 monitor the perception system 24 for the obstacle located in the region 60 located in front of the vehicle 10 in the current lane of travel 50. As mentioned above, in this situation the vehicle 10 may be attempting to perform the lane change maneuver to avoid contacting or creating a traffic incident with the obstacle located in the region 60 in front of the vehicle 10. In response to determining the obstacle is located in the region 60 located in front of the vehicle 10 and the moving obstacle 40 is located in the blind spot 42, the one or more controllers 20 instruct the braking system 28 to stop the vehicle 10 to avoid the obstacle located in the region 60 in front of the vehicle 10 instead of instructing the electric motor 34 to generate the assist torque T.

In the event there are no obstacles present in the region 60 located in front of the vehicle 10, and in response to determining the moving obstacle 40 is located in the blind spot 42 of the vehicle 10, the one or more controllers 20 instruct the electric motor 34 to generate the assist torque T provided to the hand wheel 38, where the assist torque T guides the vehicle 10 back into the current lane of travel 50. The assist torque T is of a magnitude sufficient to override a force generated by the user upon the hand wheel 38 as the lane change maneuver is initiated to nudge the vehicle 10 back into the current lane of travel 50. It is to be appreciated that the assist torque T is greater than an assist torque exerted upon the hand wheel 38 to gently nudge the vehicle 10 back into an intended lane of travel when the vehicle 10 unintentionally drifts out of the current lane of travel 50, such as when the user is distracted. As mentioned above, in another embodiment, instead of exerting the assist torque T upon the hand wheel 38 the blind spot guidance system 12 instructs the braking system 28 to adjust the trajectory of the vehicle 10 by selective braking. In this approach, the one or more controllers 20 instructs the braking system 28 to selectively brake one or more wheels 18 of the vehicle 10, where selectively braking the one or more wheels 18 of the vehicle 10 guides the vehicle 10 back into the current lane of travel 50.

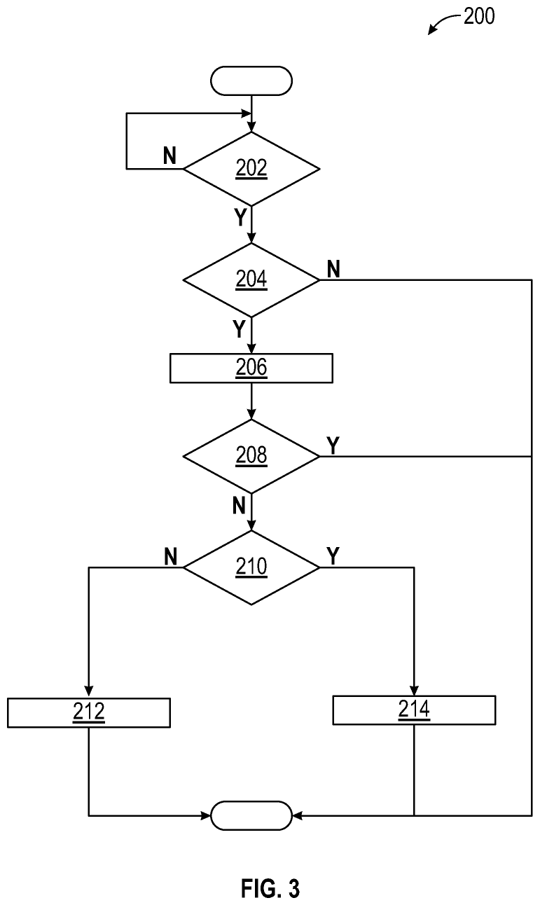

FIG. 3 is a process flow diagram illustrating an exemplary method 200 for generating the assist torque T provided to the hand wheel 38 to guide the vehicle 10 back into the current lane of travel 50 to avoid the moving obstacle 40 located in the blind spot 42 of the vehicle 10. Referring generally to FIGS. 1-3, the method 200 may begin at decision block 202. In decision block 202, the one or more controllers 20 continue to monitor the trajectory of the vehicle 10 until determining a lane change maneuver to manipulate the vehicle 10 from the current lane of travel 50 to an adjacent lane of travel 52 is being initiated. As mentioned above, the trajectory of the vehicle 10 may be determine based on the image data collected by the one or more image capturing devices 22, or by activating the turn signal system 32. In response to determining the lane change is being initiated, the method 200 may proceed to decision block 204.

In decision block 204, in response to determining the lane change maneuver is being initiated, the one or more controllers 20 monitor the perception system 24 for the moving obstacle 40 located in the blind spot 42 of the vehicle 10, where the blind spot 42 is disposed in the adjacent lane of travel 52. In response to determining the moving obstacle 40 is located in the blind spot 42 of the vehicle 10, the method 200 may proceed to block 206. Otherwise, the method 200 terminates.

In block 206, in response to determining the moving obstacle 40 is located in the blind spot 42 of the vehicle, the one or more controllers 20 activate the one or more notification devices 30 to create the alert, which notifies the user that there is a vehicle located in the blind spot 42 of the vehicle 10. The method 200 may then proceed to decision block 208.

In decision block 208, if the user stops initiating the lane change maneuver in response to the alert generated by the one or more notification devices 30, then the method 200 may terminate. However, as mentioned above, sometimes the user may disregard the alert generated by the one or more notification devices 30, and proceeds with initiating the lane change maneuver. Accordingly, the method 200 may then proceed to decision block 210.

In decision block 210, the one or more controllers 20 monitor the perception system 24 for an obstacle located in the region 60 located in front of the vehicle 10 in the current lane of travel 50. In response to determining an obstacle is located in the region 60 in front of the vehicle 10, the method 200 may proceed to block 212. In block 212, in response to determining an absence of an obstacle located in the region 60 in front of the vehicle 10, the one or more controllers 20 instruct the electric motor 34 to generate the assist torque T provided to the hand wheel 38, where the assist torque T guides the vehicle 10 back into the current lane of travel 52. As mentioned above, in another embodiment, instead of exerting the assist torque T upon the hand wheel 38 the blind spot guidance system 12 instructs the braking system 28 to adjust the trajectory of the vehicle 10 by selective braking. In this approach, the one or more controllers 20 instructs the braking system 28 to selectively brake one or more wheels 18 of the vehicle 10, where selectively braking the one or more wheels 18 of the vehicle 10 guides the vehicle 10 back into the current lane of travel 50. The method 200 may then terminate.

In response to determining an obstacle is located in the region 60 located in front of the vehicle 10, the method 200 may proceed to block 214. In block 214, the one or more controllers 20 instruct the braking system 28 to stop the vehicle 10 to avoid the obstacle located in the region 60 in front of the vehicle 10, instead of instructing the electric motor 34 to generate the assist torque T. The method 200 may then terminate.

Referring generally to the figures, the disclosed blind spot detection system provides various technical effects and benefits by providing an approach for guiding the vehicle back into its intended lane of travel when there is a moving obstacle, such as another vehicle, located in the vehicle's blind spot when the user is attempting to perform a lane change maneuver. The disclosed blind spot guidance system also checks the region in front of the vehicle, thereby ensuring that the ego vehicle may not create a traffic incident with another vehicle located in the region in front of the ego vehicle while trying to avoid an obstacle in the blind spot. Accordingly, the disclosed blind spot guidance system provides a robust collision avoidance solution.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A blind spot guidance system for a vehicle, the blind spot guidance system comprising:
a perception system collecting perception data indicating objects located in an environment surrounding the vehicle;
an electric motor providing an assist torque to a hand wheel of the vehicle; and
one or more controllers in electronic communication with the perception system and the electric motor, the one or more controllers executing instructions to:
monitor a trajectory of the vehicle to determine when a lane change maneuver to manipulate the vehicle from a current lane of travel to an adjacent lane of travel is being initiated;
in response to determining the lane change maneuver is being initiated, monitor the perception data collected by the perception system for a moving obstacle located in a blind spot of the vehicle, wherein the blind spot is disposed in the adjacent lane of travel; and
in response to determining the moving obstacle is located in the blind spot of the vehicle, instruct the electric motor to generate the assist torque provided to the hand wheel, wherein the assist torque guides the vehicle back into the current lane of travel.

2. The blind spot guidance system of claim 1, further comprising:
one or more notification devices in electronic communication with the one or more controllers, wherein the one or more notification devices are activated to create an alert.

3. The blind spot guidance system of claim 2, wherein the one or more controllers execute instructions to:
in response to determining the moving obstacle is located in the blind spot of the vehicle, activate the one or more notification devices to create the alert.

4. The blind spot guidance system of claim 1, wherein the assist torque overrides a force generated by a user upon the hand wheel as the lane change maneuver is initiated.

5. The blind spot guidance system of claim 1, further comprising:
one or more image capturing devices that collect image data representative of an environment surrounding the vehicle.

6. The blind spot guidance system of claim 5, wherein the one or more controllers determine the trajectory of the vehicle based on the image data collected by the one or more image capturing devices.

7. The blind spot guidance system of claim 6, wherein the one or more controllers execute instructions to:
detect lane lines along a roadway that the vehicle is traveling along based on the image data collected by the one or more image capturing devices;
measure a distance between the vehicle and the lane lines along the roadway;
compare the distance with a lane change prediction distance, wherein the lane change prediction distance represents a predefined distance indicating a user of the vehicle is approaching the lane lines and intends to perform the lane change maneuver;
determine the distance between the vehicle and the lane lines is equal to or greater than the lane change prediction distance for a predefined amount of time; and
in response to determining the distance between the vehicle and the lane lines is equal to or greater than the lane change prediction distance for the predefined amount of time, determine the lane change maneuver is being initiated.

8. The blind spot guidance system of claim 1, further comprising a turn signal system in electronic communication with the one or more controllers.

9. The blind spot guidance system of claim 8, wherein the one or more controllers determine the trajectory of the vehicle based on the turn signal system being activated.

10. The blind spot guidance system of claim 1,
in response to determining the moving obstacle is located in the blind spot of the vehicle, monitor the perception system for an obstacle located in in a region located in front of the vehicle in the current lane of travel.

11. A blind spot guidance system for a vehicle, the blind spot guidance system comprising:
a perception system collecting perception data indicating objects located in an environment surrounding the vehicle;
an electric motor providing an assist torque to a hand wheel of the vehicle;
a braking system; and
one or more controllers in electronic communication with the perception system, the electric motor, and the braking system, the one or more controllers executing instructions to:
monitor a trajectory of the vehicle to determine when a lane change maneuver to manipulate the vehicle from a current lane of travel to an adjacent lane of travel is being initiated;
in response to determining the lane change maneuver is being initiated, monitor the perception data collected by the perception system for a moving obstacle located in a blind spot of the vehicle, wherein the blind spot is disposed in the adjacent lane of travel;
determine the moving obstacle is located in the blind spot of the vehicle;
in response to determining the moving obstacle is located in the blind spot of the vehicle, monitor the perception system for an obstacle located in a region located in front of the vehicle in the current lane of travel;
in response to determining an absence of the obstacle in the region located in front of the vehicle, instruct the electric motor to generate the assist torque that is provided to the hand wheel, wherein the assist torque guides the vehicle back into the current lane of travel; and
in response to determining the obstacle is located in the region located in front of the vehicle, instruct the braking system to stop the vehicle within a speed-defined distance to avoid the obstacle located in the region in front of the vehicle.

12. The blind spot guidance system of claim 11, further comprising:
one or more notification devices in electronic communication with the one or more controllers, wherein the one or more notification devices create an alert, and wherein the alert is a haptic alert, an audio alert, or a visual alert.

13. The blind spot guidance system of claim 12, wherein the one or more controllers execute instructions to:
in response to determining the moving obstacle is located in the blind spot of the vehicle, activate the one or more notification devices to create the alert.

14. The blind spot guidance system of claim 11, wherein the assist torque overrides a force generated by a user upon the hand wheel as the lane change maneuver is initiated.

15. The blind spot guidance system of claim 11, further comprising:
one or more image capturing devices that collect image data representative of an environment surrounding the vehicle.

16. The blind spot guidance system of claim 15, wherein the one or more controllers determine the trajectory of the vehicle based on the image data collected by the one or more image capturing devices.

17. The blind spot guidance system of claim 16, wherein the one or more controllers execute instructions to:
detect lane lines along a roadway that the vehicle is traveling along based on the image data collected by the one or more image capturing devices;
measure a distance between the vehicle and the lane lines along the roadway;
compare the distance with a lane change prediction distance, wherein the lane change prediction distance represents a predefined distance indicating a user of the vehicle is approaching the lane lines and intends to perform the lane change maneuver;
determine the distance between the vehicle and the lane lines is equal to or greater than the lane change prediction distance for a predefined amount of time; and
in response to determining the distance between the vehicle and the lane lines is equal to or greater than the lane change prediction distance for the predefined amount of time, determine the lane change maneuver is being initiated.

18. The blind spot guidance system of claim 11, further comprising a turn signal system in electronic communication with the one or more controllers.

19. The blind spot guidance system of claim 18, wherein the one or more controllers determine the trajectory of the vehicle based on the turn signal system being activated.

20. A blind spot guidance system for a vehicle, the blind spot guidance system comprising:
a perception system collecting perception data indicating objects located in an environment surrounding the vehicle;
a braking system including a set of brakes corresponding to each wheel of a plurality of wheels of the vehicle; and
one or more controllers in electronic communication with the perception system and the braking system, the one or more controllers executing instructions to:
monitor a trajectory of the vehicle to determine when a lane change maneuver to manipulate the vehicle from a current lane of travel to an adjacent lane of travel is being initiated;
in response to determining the lane change maneuver is being initiated, monitor the perception data collected by the perception system for a moving obstacle located in a blind spot of the vehicle, wherein the blind spot is disposed in the adjacent lane of travel; and
in response to determining the moving obstacle is located in the blind spot of the vehicle, instruct the braking system to selectively brake one or more wheels of the vehicle, wherein selectively braking the one or more wheels of the vehicle guides the vehicle back into the current lane of travel.
